(19) United States
(12) Patent Application Publication
(10) Pub. No.: US 2019/0284658 A1
(43) Pub. Date: Sep. 19, 2019

(54) DEVICE FOR FRACTIONAL CONDENSATION OF ARSENIC LEAD VAPOR MIXTURE AND APPLICATION METHOD THEREOF

(71) Applicant: Kunming University of Science and Technology, Kunming (CN)

(72) Inventors: Yifu Li, Kunming (CN); Zhenghao Pu, Kunming (CN); Bin Yang, Kunming (CN); Baoqiang Xu, Kunming (CN); Dachun Liu, Kunming (CN); Yang Tian, Kunming (CN); Wenlong Jiang, Kunming (CN); Neng Xiong, Kunming (CN); Huan Zhang, Kunming (CN)

(21) Appl. No.: 16/352,199

(22) Filed: Mar. 13, 2019

(30) Foreign Application Priority Data
Mar. 13, 2018 (CN) 201810202775.5

(51) Int. Cl. C22B 9/02; B01D 3/10; C22B 13/02; C22B 30/04; B01D 3/42

(52) U.S. Cl. CPC C22B 9/02; B01D 3/10; B01D 3/42; C22B 30/04; C22B 13/02

(57) ABSTRACT

A device is provided for fractional condensation of an arsenic-lead vapor mixture and an application method thereof. The device includes a vacuumizing device, a flange, temperature measuring devices, a graded vacuum furnace body, a quartz tube, a push rod, a control cabinet, a heating zone and recycled foil. The length of the quartz tube is 1.2-2 m; the length of the heating zone is 0.15-0.25 m; and the quartz tube is provided with one temperature measuring device every 2-3 cm. The device forms a certain temperature gradient in the quartz tube, so that a material condenses in the corresponding temperature range, thereby achieving the purpose of high-efficiency separation.

### CROSS-REFERENCE TO RELATED APPLICATION

This application claims priority to Chinese application number 201810202775.5, filed Mar. 13, 2018. The above-mentioned patent application is incorporated herein by reference in its entirety.

### TECHNICAL FIELD

The present invention relates to a device for fractional condensation of an arsenic-lead vapor mixture and an application method thereof, and more particularly, relates to alloy separation equipment and methods.

### BACKGROUND

Arsenic and lead are main elements causing environmental pollution in the process of smelting and recycling non-ferrous metals. Conventional methods of treating such materials include high-temperature melting segregation or electrolysis, but such methods have high energy consumption and easily cause harm to the environment. Vacuum distillation is a green and environment-friendly method for smelting that can be used in metallurgical production processes. However, it is difficult for a conventional vacuum distillation device to control the temperature, causing volatiles to condense together, which is not conducive to recycling.

Chinese Patent Application No. 201210040524.4 discloses a method for environmental protection treatment of tin smelting aluminum slag. The method includes reducing and smelting aluminum slag through a shaft furnace. During this process, the harmful elements arsenic, antimony and tin form a tin-arsenic-antimony alloy, and electrolyzing the tin-arsenic-antimony alloy to obtain soldering tin and anode mud rich in antimony, arsenic and silver, thereby achieving the purpose of separating tin from arsenic and antimony. However, the steps of this method are complicated. And a large amount of waste water is generated by electrolysis, which is not conducive to environmental protection requirements.

Chinese Patent Application No. 200910095112.9 discloses a method for separating a lead-bismuth-gold-silver-copper multi-element alloy. The method includes treating the multi-element alloy by vacuum distillation, where the distillation temperature is 1050-1100° C., distillation, the distillation time is 60-80 min, the vacuum in a furnace is 5-15 Pa. The material can be separated into a volatile (a lead-bismuth alloy) and a residue (a gold-silver-copper alloy). However, the volatile collected by this method is still an alloy, which needs further separation, thus restricting the wide application and development of a vacuum furnace.

Therefore, it would be desirable to develop a method for efficiently separating an arsenic-lead material to recycle simple substances arsenic and lead, which simplifies a process, is safe, efficient and free of pollution, and reduces element loss.

### SUMMARY

To address the above problems and deficiencies of the prior art and to achieve the above purposes, the present invention provides a device for fractional condensation of an arsenic-lead vapor mixture and an application method thereof. The device forms a certain temperature gradient in a quartz tube, so that a material condenses in the corresponding temperature range, thereby achieving the purpose of high-efficiency separation.

In one embodiment of the invention, a device for fractional condensation of an arsenic-lead vapor mixture includes a vacuumizing device, a flange, temperature measuring devices, a graded vacuum furnace body, a quartz tube, a push rod, a control cabinet, a heating zone and recycled foil, where one end of the quartz tube is connected with the vacuumizing device through the flange, and the other end of the quartz tube is internally sealed and provided with the push rod that can move inside the quartz tube; the quartz tube is internally provided with a recycled foil layer, the quartz tube is provided in the middle thereof with the heating zone, and the quartz tube is externally provided with a furnace shell to form the graded vacuum furnace body; the plurality of temperature measuring devices are evenly inserted in the top of the graded vacuum furnace body, and each temperature measuring device is in contact with the top of the quartz tube; the bottom of the graded vacuum furnace body is provided with the control cabinet, and a controller in the control cabinet is respectively electrically connected with a heating device of the heating zone, the plurality of temperature measuring devices and a mechanical pump of the vacuumizing device; and the length of the quartz tube is 1.2-2 m; the length of the heating zone is 0.15-0.25 m; and the quartz tube is provided with one temperature measuring device every 2-3 cm.

In one aspect, the temperature measuring device is a K-type or Pt—Rh type thermocouple.

In another aspect, the heating device of the heating zone carries out heating by resistance.

In a further aspect, the recycled foil is graphite foil or metal foil, with a thickness of 0.2-0.4 mm.

An application method of a device for fractional condensation of an arsenic-lead vapor mixture includes the following specific steps:
step 1: placing an arsenic-lead material in a quartz tube and pressing the arsenic-lead material with a push rod, and then sealing one side of the quartz tube provided with the push rod; controlling, by a controller, a vacuumizing device to vacuumize the inside of the quartz tube to 0.1-50 Pa, controlling the heating temperature of a heating device of a heating zone to be 800-1100° C., and then pushing the arsenic-lead material to the heating zone by the push rod; maintaining the temperature for 60-120 min for vacuum distillation to obtain arsenic vapor and lead vapor;
step 2: the temperature of an area of the quartz tube close to the heating zone being high, the temperatures of areas at both sides of the quartz tube being low, condensing the lead vapor obtained by vacuum distillation in step 1 in a recycled foil area which is at a temperature of 480-700° C. and is close to the heating zone, and condensing the arsenic vapor obtained by vacuum distillation in step 1 in a low-temperature recycled foil area which is at a temperature of 110-300° C.

In some embodiments, the arsenic-lead material has an arsenic content of 1-50 wt %.

The beneficial effects of the present invention are as follows.

In the process of distillation of the present invention, a certain temperature gradient can be formed in the quartz tube by controlling the heating temperature and the heat preservation time. The material condenses in the corresponding temperature range, thereby achieving the purpose of high-efficiency separation.

The temperature of the heating zone can be adjusted according to the temperature fed back by the thermocouple, and the temperature gradient is controlled to achieve accurate material recycling.

The device and method of these embodiments can be used not only for treating the arsenic-lead material, but also for treating various metal alloys with different condensation properties such as a lead-bismuth alloy and a lead-arsenic-antimony alloy. The use process is safe and free of pollution. At the same time, basic theoretical studies on alloy separation and purification techniques can be carried out using the device of the present invention.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitutes a part of this specification, illustrate one or more embodiments of the invention and, together with the general description given above and the detailed description given below, explain the one or more embodiments of the invention.

FIG. 1 is a schematic structural view of a device for fractional condensation of an arsenic-lead vapor mixture, according to one embodiment of the present invention.

FIG. 2 is a schematic cross-sectional structural view of a graded vacuum furnace body of the device of FIG. 1.

FIG. 3 is a pictorial view of a real product obtained by segmentally condensing graphite foil according to an Embodiment 1 described below.

FIG. 4 is a pictorial view of a real product obtained by segmentally condensing graphite foil according to an Embodiment 2 described below.

### DETAILED DESCRIPTION

The following clearly and completely describes the technical solutions in the embodiments of the present invention with reference to the accompanying drawings in the embodiments of the present invention. To make objectives, features, and advantages of the present invention clearer, the following describes embodiments of the present invention in more detail with reference to accompanying drawings and specific implementations. The present invention will be further described below with reference to the accompanying drawings and specific embodiments.

### Embodiment 1

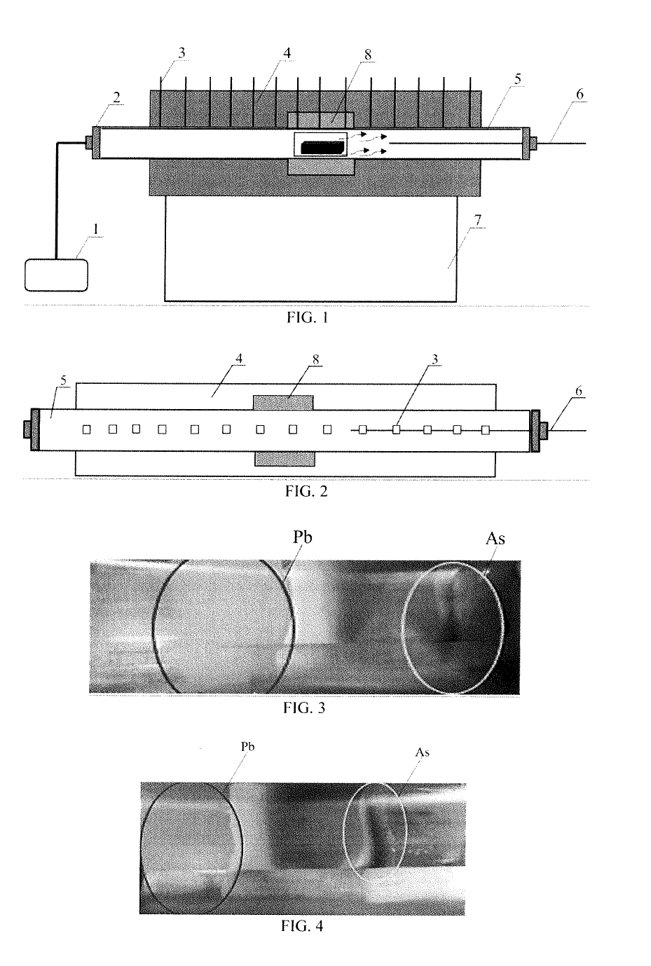

As shown in FIG. 1 and FIG. 2, the device for fractional condensation of an arsenic-lead vapor mixture includes a vacuumizing device 1, a flange 2, temperature measuring devices 3, a graded vacuum furnace body 4, a quartz tube 5, a push rod 6, a control cabinet 7, a heating zone 8 and recycled foil, where one end of the quartz tube 5 is connected with the vacuumizing device 1 through the flange 2, and the other end of the quartz tube 5 is internally sealed and provided with the push rod 6 that can move inside the quartz tube 5; the quartz tube 5 is internally provided with a recycled foil layer, the quartz tube 5 is provided in the middle thereof with the heating zone 8, and the quartz tube 5 is externally provided with a furnace shell to form the graded vacuum furnace body 4; the plurality of temperature measuring devices 3 are evenly inserted in the top of the graded vacuum furnace body 4, and each temperature measuring device 3 is in contact with the top of the quartz tube 5; the bottom of the graded vacuum furnace body 4 is provided with the control cabinet 7, and a controller in the control cabinet 7 is respectively electrically connected with a heating device of the heating zone 8, the plurality of temperature measuring devices 3 and a mechanical pump of the vacuumizing device 1; where the length of the quartz tube 5 is 1.2 m; the length of the heating zone 8 is 0.15 m; the quartz tube 5 is provided with one temperature measuring device 3 every 2 cm; the temperature measuring device 3 is a K-type thermocouple; the heating device of the heating zone 8 carries out heating by resistance; and the recycled foil is graphite foil, with a thickness of 0.2 mm.

An application method for the above device for fractional condensation of an arsenic-lead vapor mixture includes the following specific steps:
step 1: 20 g of arsenic-lead material (the arsenic-lead material includes 3.34 wt % of arsenic, and the balance lead) was placed in a quartz tube 5 and the arsenic-lead material was pressed with a push rod 6, and then one side of the quartz tube 5 provided with the push rod 6 was sealed; a controller controlled a vacuumizing device 1 to vacuumize the inside of the quartz tube 5 to 1-10 Pa, the heating temperature of a heating device of a heating zone 8 was controlled to be 850° C., and then the arsenic-lead material was pushed to the heating zone 8 by the push rod 6; the temperature was maintained for 100 min for vacuum distillation to obtain arsenic vapor and lead vapor;
step 2: The temperature of an area of the quartz tube 5 close to the heating zone 8 was high, and the temperatures of areas at both sides of the quartz tube 5 were low; the lead vapor obtained by vacuum distillation in step 1 was condensed in a recycled foil area which was at a temperature of 510-700° C. and was close to the heating zone 8, and the arsenic vapor obtained by vacuum distillation in step 1 was condensed in a low-temperature recycled foil area which was at a temperature of 120-300° C.; a picture of a real product obtained by segmental condensation of graphite foil was shown in FIG. 3, and crude lead having a purity of 99.82 wt % and crude arsenic having a purity of 99.91 wt % were obtained by condensation.

### Embodiment 2

As shown in FIG. 1 and FIG. 2, the device for fractional condensation of an arsenic-lead vapor mixture includes a vacuumizing device 1, a flange 2, temperature measuring devices 3, a graded vacuum furnace body 4, a quartz tube 5, a push rod 6, a control cabinet 7, a heating zone 8 and recycled foil, where one end of the quartz tube 5 is connected with the vacuumizing device 1 through the flange 2, and the other end of the quartz tube 5 is internally sealed and provided with the push rod 6 that can move inside the quartz tube 5; the quartz tube 5 is internally provided with a recycled foil layer, the quartz tube 5 is provided in the middle thereof with the heating zone 8, and the quartz tube 5 is externally provided with a furnace shell to form the graded vacuum furnace body 4; the plurality of temperature measuring devices 3 are evenly inserted in the top of the graded vacuum furnace body 4, and each temperature measuring device 3 is in contact with the top of the quartz tube 5; the bottom of the graded vacuum furnace body 4 is provided with the control cabinet 7, and a controller in the control cabinet 7 is respectively electrically connected with a heating device of the heating zone 8, the plurality of temperature measuring devices 3 and a mechanical pump of the vacuumizing device 1; where the length of the quartz tube 5 is 1.2 m; the length of the heating zone 8 is 0.15 m; the quartz tube 5 is provided with one temperature measuring device 3 every 2 cm; the temperature measuring device 3 is a Pt—Rh-type thermocouple; the heating device of the heating zone 8 carries out heating by resistance; and the recycled foil is graphite foil, with a thickness of 0.2 mm.

An application method for the above device for fractional condensation of an arsenic-lead vapor mixture includes the following specific steps:
step 1: 30 g of arsenic-lead material (the arsenic-lead material was a tin-lead-arsenic alloy which included 30 wt % of tin, 5 wt % of arsenic, and the balance lead) was placed in a quartz tube 5 and the arsenic-lead material was pressed with a push rod 6, and then one side of the quartz tube 5 provided with the push rod 6 was sealed; a controller controlled a vacuumizing device 1 to vacuumize the inside of the quartz tube 5 to 1-10 Pa, the heating temperature of a heating device of a heating zone 8 was controlled to be 900° C., and then the arsenic-lead material was pushed to the heating zone 8 by the push rod 6; the temperature was maintained for 60 min for vacuum distillation to obtain arsenic vapor and lead vapor, and tin remaining in a crucible;
step 2: The temperature of an area of the quartz tube 5 close to the heating zone 8 was high, and the temperatures of areas at both sides of the quartz tube 5 were low; the lead vapor obtained by vacuum distillation in step 1 was condensed in a recycled foil area which was at a temperature of 480-680° C. and was close to the heating zone 8, and the arsenic vapor obtained by vacuum distillation in step 1 was condensed in a low-temperature recycled foil area which was at a temperature of 110-280° C.; a picture of a real product obtained by segmental condensation of graphite foil was shown in FIG. 4, and crude lead having a purity of 99.91 wt % and crude arsenic having a purity of 99.87 wt %, and crude tin having a purity of 99.32 wt % in the crucible were obtained by condensation.

### Embodiment 3

As shown in FIG. 1 and FIG. 2, the device for fractional condensation of an arsenic-lead vapor mixture includes a vacuumizing device 1, a flange 2, temperature measuring devices 3, a graded vacuum furnace body 4, a quartz tube 5, a push rod 6, a control cabinet 7, a heating zone 8 and recycled foil, where one end of the quartz tube 5 is connected with the vacuumizing device 1 through the flange 2, and the other end of the quartz tube 5 is internally sealed and provided with the push rod 6 that can move inside the quartz tube 5; the quartz tube 5 is internally provided with a recycled foil layer, the quartz tube 5 is provided in the middle thereof with the heating zone 8, and the quartz tube 5 is externally provided with a furnace shell to form the graded vacuum furnace body 4; the plurality of temperature measuring devices 3 are evenly inserted in the top of the graded vacuum furnace body 4, and each temperature measuring device 3 is in contact with the top of the quartz tube 5; the bottom of the graded vacuum furnace body 4 is provided with the control cabinet 7, and a controller in the control cabinet 7 is respectively electrically connected with a heating device of the heating zone 8, the plurality of temperature measuring devices 3 and a mechanical pump of the vacuumizing device 1; where the length of the quartz tube 5 is 2 m; the length of the heating zone 8 is 0.25 m; the quartz tube 5 is provided with one temperature measuring device 3 every 3 cm; the temperature measuring device 3 is a K-type thermocouple; the heating device of the heating zone 8 carries out heating by resistance; and the recycled foil is graphite foil, with a thickness of 0.4 mm.

An application method for the above device for fractional condensation of an arsenic-lead vapor mixture includes the following specific steps:
step 1: 20 g of arsenic-lead material (the arsenic-lead material included 1 wt % of arsenic, and the balance lead) was placed in a quartz tube 5 and the arsenic-lead material was pressed with a push rod 6, and then one side of the quartz tube 5 provided with the push rod 6 was sealed; a controller controlled a vacuumizing device 1 to vacuumize the inside of the quartz tube 5 to 0.1-5 Pa, the heating temperature of a heating device of a heating zone 8 was controlled to be 800° C., and then the arsenic-lead material was pushed to the heating zone 8 by the push rod 6; the temperature was maintained for 120 min for vacuum distillation to obtain arsenic vapor and lead vapor;
step 2: The temperature of an area of the quartz tube 5 close to the heating zone 8 was high, and the temperatures of areas at both sides of the quartz tube 5 were low; the lead vapor obtained by vacuum distillation in step 1 was condensed in a recycled foil area which was at a temperature of 500-660° C. and was close to the heating zone 8, and the arsenic vapor obtained by vacuum distillation in step 1 was condensed in a low-temperature recycled foil area which was at a temperature of 110-220° C.

### Embodiment 4

As shown in FIG. 1 and FIG. 2, the device for fractional condensation of an arsenic-lead vapor mixture includes a vacuumizing device 1, a flange 2, temperature measuring devices 3, a graded vacuum furnace body 4, a quartz tube 5, a push rod 6, a control cabinet 7, a heating zone 8 and recycled foil, where one end of the quartz tube 5 is connected with the vacuumizing device 1 through the flange 2, and the other end of the quartz tube 5 is internally sealed and provided with the push rod 6 that can move inside the quartz tube 5; the quartz tube 5 is internally provided with a recycled foil layer, the quartz tube 5 is provided in the middle thereof with the heating zone 8, and the quartz tube 5 is externally provided with a furnace shell to form the graded vacuum furnace body 4; the plurality of temperature measuring devices 3 are evenly inserted in the top of the graded vacuum furnace body 4, and each temperature measuring device 3 is in contact with the top of the quartz tube 5; the bottom of the graded vacuum furnace body 4 is provided with the control cabinet 7, and a controller in the control cabinet 7 is respectively electrically connected with a heating device of the heating zone 8, the plurality of temperature measuring devices 3 and a mechanical pump of the vacuumizing device 1; where the length of the quartz tube 5 is 1.8 m; the length of the heating zone 8 is 0.20 m; the quartz tube 5 is provided with one temperature measuring device 3 every 3 cm; the temperature measuring device 3 is a K-type thermocouple; the heating device of the heating zone 8 carries out heating by resistance; and the recycled foil is silver foil, with a thickness of 0.3 mm.

An application method for the above device for fractional condensation of an arsenic-lead vapor mixture includes the following specific steps:
step 1: 20 g of arsenic-lead material (the arsenic-lead material included 1 wt % of arsenic, and the balance lead) was placed in a quartz tube 5 and the arsenic-lead material was pressed with a push rod 6, and then one side of the quartz tube 5 provided with the push rod 6 was sealed; a controller controlled a vacuumizing device 50 to vacuumize the inside of the quartz tube 5 to 40-50 Pa, the heating temperature of a heating device of a heating zone 8 was controlled to be 1100° C., and then the arsenic-lead material was pushed to the heating zone 8 by the push rod 6; the temperature was maintained for 60 min for vacuum distillation to obtain arsenic vapor and lead vapor;
step 2: The temperature of an area of the quartz tube 5 close to the heating zone 8 was high, and the temperatures of areas at both sides of the quartz tube 5 were low; the lead vapor obtained by vacuum distillation in step 1 was condensed in a recycled foil area which was at a temperature of 520-700° C. and was close to the heating zone 8, and the arsenic vapor obtained by vacuum distillation in step 1 was condensed in a low-temperature recycled foil area which was at a temperature of 180-300° C.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

The embodiments described above are only descriptions of preferred embodiments of the present invention, and do not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

What is claimed is:

1.-6. (canceled)

7. A device for fractional condensation of an arsenic-lead vapor mixture, comprising:
a vacuumizing device,
a flange,
a plurality of temperature measuring devices,
a graded vacuum furnace body,
a quartz tube,
a push rod,
a control cabinet,
a heating zone, and
recycled foil,
wherein one end of the quartz tube is connected with the vacuumizing device through the flange, and another end of the quartz tube is internally sealed and provided with the push rod that can move inside the quartz tube;
the quartz tube is internally provided with a recycled foil layer, the quartz tube is provided in the middle thereof with the heating zone, and the quartz tube is externally provided with a furnace shell to form the graded vacuum furnace body;
the plurality of temperature measuring devices are evenly inserted in the top of the graded vacuum furnace body, and each of the temperature measuring devices is in contact with the top of the quartz tube;
a bottom of the graded vacuum furnace body is provided with the control cabinet, and a controller in the control cabinet is respectively electrically connected with a heating device of the heating zone, the plurality of temperature measuring devices and a mechanical pump of the vacuumizing device; and
a length of the quartz tube is 1.2-2 m; a length of the heating zone is 0.15-0.25 m; and the quartz tube is provided with one of the temperature measuring devices every 2-3 cm.

8. The device of claim 7, wherein each of the temperature measuring devices is a K-type or Pt—Rh type thermocouple.

9. The device of claim 7, wherein the heating device of the heating zone carries out heating by resistance.

10. The device of claim 7, wherein the recycled foil is defined by graphite foil or metal foil, having a thickness of 0.2-0.4 mm.

11. An application method of a device for fractional condensation of an arsenic-lead vapor mixture, comprising:
providing the device for fractional condensation of an arsenic-lead vapor mixture such that it includes a vacuumizing device, a flange, a plurality of temperature measuring devices, a graded vacuum furnace body, a quartz tube, a push rod, a control cabinet, a heating zone, and recycled foil, wherein one end of the quartz tube is connected with the vacuumizing device through the flange, and another end of the quartz tube is internally sealed and provided with the push rod that can move inside the quartz tube; the quartz tube is internally provided with a recycled foil layer, the quartz tube is provided in the middle thereof with the heating zone, and the quartz tube is externally provided with a furnace shell to form the graded vacuum furnace body; the plurality of temperature measuring devices are evenly inserted in the top of the graded vacuum furnace body, and each of the temperature measuring devices is in contact with the top of the quartz tube; a bottom of the graded vacuum furnace body is provided with the control cabinet, and a controller in the control cabinet is respectively electrically connected with a heating device of the heating zone, the plurality of temperature measuring devices and a mechanical pump of the vacuumizing device; and a length of the quartz tube is 1.2-2 m; a length of the heating zone is 0.15-0.25 m; and the quartz tube is provided with one of the temperature measuring devices every 2-3 cm;
placing an arsenic-lead material in the quartz tube and pressing the arsenic-lead material with the push rod, and then sealing one side of the quartz tube provided with the push rod; controlling, by the controller, the vacuumizing device to vacuumize the inside of the quartz tube to 0.1-50 Pa, controlling the heating temperature of a heating device of the heating zone to be 800-1100° C., and then pushing the arsenic-lead material to the heating zone by the push rod; maintaining the heating temperature for 60-120 min for vacuum distillation to obtain arsenic vapor and lead vapor;
with a temperature of an area of the quartz tube close to the heating zone being high, and temperatures of areas at both sides of the quartz tube being low, condensing the lead vapor obtained by vacuum distillation in a recycled foil area which is at a temperature of 480-700° C. and is close to the heating zone, and condensing the arsenic vapor obtained by vacuum distillation in a low-temperature recycled foil area at a temperature of 110-300° C.

12. The application method of claim 11, wherein the arsenic-lead material has an arsenic content of 1-50 wt %.

13. The application method of claim 11, wherein each of the temperature measuring devices is a K-type or Pt—Rh type thermocouple.

14. The application method of claim 13, wherein the arsenic-lead material has an arsenic content of 1-50 wt %.

15. The application method of claim 11, wherein the heating device of the heating zone carries out heating by resistance.

16. The application method of claim 15, wherein the arsenic-lead material has an arsenic content of 1-50 wt %.

17. The application method of claim 11, wherein the recycled foil is defined by graphite foil or metal foil, having a thickness of 0.2-0.4 mm.

18. The application method of claim 17, wherein the arsenic-lead material has an arsenic content of 1-50 wt %.
